(19) United States
(12) Patent Application Publication
(10) Pub. No.: US 2026/0124747 A1
(43) Pub. Date: May 7, 2026

(54) CONTROL METHOD OF ROBOTIC ARM AND CONTROL SYSTEM THEREOF

(71) Applicant: TECHMAN ROBOT INC., Taoyuan City (TW)

(72) Inventors: Ching-Wei LEE, Taoyuan City (TW); Kuei-You Lin, Taoyuan City (TW); Chun-Wen Lai, Taoyuan City (TW)

(21) Appl. No.: 19/359,748

(22) Filed: Oct. 16, 2025

(30) Foreign Application Priority Data
Nov. 4, 2024 (TW) 113142084

(51) Int. Cl. B25J 9/16

(52) U.S. Cl. CPC B25J 9/1633

(57) ABSTRACT

A control method of a robotic arm is provided by an aspect of the present disclosure. The control method comprises using a driver for outputting a first driving force to control the robotic arm held in a first position, and using the driver for outputting a second driving force to control the robotic arm held in a second position. The second position is different to the first position. The control method also comprises the first driving force and the second driving force respectively having an anti-friction force and a kinetic force. The anti-friction force is greater than the kinetic force. The control method also comprises using a control loop, the first position and the second position for adjusting the second driving force to control the robotic arm. The first position and the second position are related to a friction force of the robotic arm.

This application claims the benefit of Taiwan patent application Serial No. 113142084, filed Nov. 4, 2024, the subject matter of which is incorporated herein by reference.

### TECHNICAL FIELD

The disclosure relates in general to techniques of control method and control system of robotic arm, and more particularly, to techniques of control method and control system of joint motor in robotic arm.

### BACKGROUND

Currently, with the development of automated production, the demand for robotic arms has increased. The performance of robotic arms, such as control techniques of robotic arms, has also attracted the attention of various manufacturers. For improving the control accuracy of the robotic arm, the conventional method adjusts the control gain according to the angular velocity. For example, when the angular velocity is less than a threshold value, the gain is reduced linearly or in a curve to achieve the purpose of control. However, such conventional techniques cannot handle the state of the robot arm when it is running at an extremely low speed, moving in small steps, or at static state. Because in these states, the torque output by the joint motor will be affected by the friction force, causing the robot arm to swing back and forth or move suddenly, resulting in reduced accuracy and performance of the robotic arm, which may cause the robotic arm to accidentally reach the safety threshold and may cause the manufacturing line to stop. Thus, there are needs for techniques of improving performance and accuracy of static state or small movement of robotic arms.

### SUMMARY

According to techniques of control method and control system of robotic arm provided by the implementations of the present disclosure, by comparing the absolute difference of the torque command between the current torque command information and the prior torque command information with the counting threshold, and substituting the absolute difference of the position between the command position information and the actual position information into the gain mapping curve, the current (new) gain value is obtained and updated to the controller. In this way, when the robotic arm is at static state or moves slightly, the control accuracy of the joint motor is improved, thereby improving the performance of the robotic arm and reducing the problems of shutdown or manufacturing line being stopped caused by the movement state of the robotic arm accidentally reaching the safety threshold. In addition, due to the improved control ability of friction, the influence of the variability of the joint motor and the mechanical components of the robotic arm can be reduced.

The first aspect of the present disclosure features a control method of a robotic arm. The control method includes outputting, by a driver, a first driving force to control the robotic arm located in a first position. The control method also includes outputting, by the driver, a second driving force to control the robotic arm located in a second position. The first position is different to the second position, and the first driving force and the second driving force respectively include an anti-friction force and a kinetic force smaller than the anti-friction force. The control method also includes adjusting, by using a control loop, the first position and the second position, the second driving force to control the robotic arm. The first position and the second position are related to a friction force of the robotic arm.

The second aspect of the present disclosure features a control system of a robotic arm. The control system includes a driver, configured to output a first driving force to control the robotic arm located in a first position and output a second driving force to control the robotic arm located in a second position. The first position is different to the second position, and the first driving force and the second driving force respectively include an anti-friction force and a kinetic force smaller than the anti-friction force. The control system also includes a control loop configured to adjust the second driving force to control the robotic arm according to the first position and the second position. The first position and the second position are related to a friction force of the robotic arm.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a function block diagram illustrating an example of robotic arm and control system, according to some implementations of the present disclosure.

FIG. 2 is a diagram illustrating a gain mapping curve graph of control system, according to some implementations of the present disclosure.

FIG. 3A is a diagram illustrating a moving speed comparison between conventional joint motor and the joint motor according to some implementations of the present disclosure.

FIG. 3B is a diagram illustrating a moving torque comparison between conventional robotic arm and the robotic arm according to some implementations of the present disclosure.

FIG. 3C is a diagram illustrating a moving position comparison between conventional joint motor and the joint motor according to some implementations of the present disclosure.

FIG. 4 is a flowchart illustrating control operations of robotic arm and joint motor according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

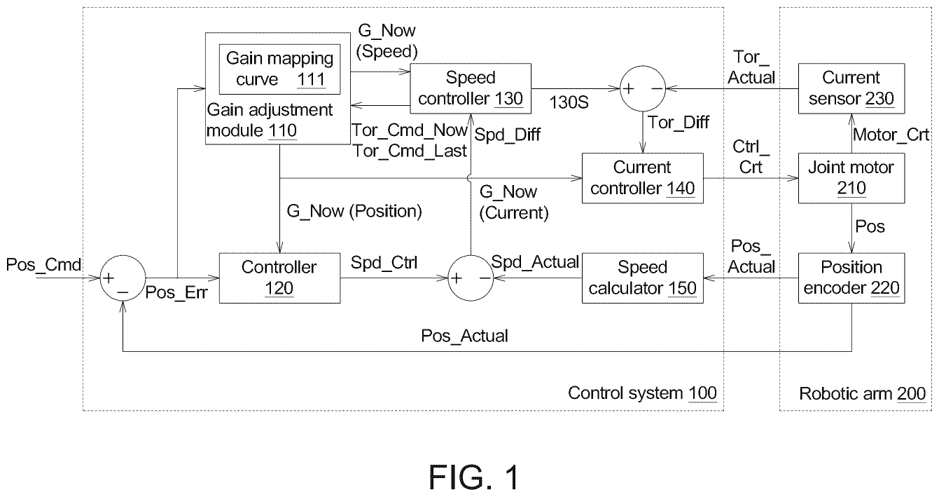

FIG. 1 is a function block diagram illustrating an example of robotic arm 200 and control system 100, according to some implementations of the present disclosure. As shown by FIG. 1, the control system 100 is coupled to the robotic arm 200 for controlling the movement status of the robotic arm 200. The robotic arm 200 includes a position decoder 220 for sensing rotation state (Pos) of the joint motor 210, and a current sensor 230 for sensing motor current (Motor_Crt) of the joint motor 210. In some implementations, the position decoder 220 can be selected as an optical encoder with different resolutions (Resolution), which is used to indicate how many values (scales) a circle of the encoder can be divided into. For example, a circle can be divided into 100000 Pulses to represent information of a circle with 360 degrees.

The control system 100 includes a controller 120 (can be also referred as position controller) coupled to the position decoder 220 of the robotic arm 200. The controller 120 receives position absolute difference value (Pos_Err) between command position information (Pos_Cmd) and actual position information (Pos_Actual) provided by the position decoder 220. The position absolute difference value (Pos_Err) can be obtained by an adder according to the command position information (Pos_Cmd) and the actual position information (Pos_Actual), as shown by FIG. 1. Wherein, command position information (Pos_Cmd) is the position command for controlling the motion position of the robotic arm 200, such as the position command for controlling rotation position of the joint motor 210; and the actual position information (Pos_Actual) is the rotation state (Pos) of the joint motor 210 read by the position decoder 220, which indicates the actual rotation position of the joint motor 210 and is related to the actual motion position of the robotic arm 200. In other words, the joint motor 210 is the driver of the robotic arm 200.

The control system 100 includes a speed controller 130 coupled to the controller 120. The speed controller 130 generates torque command information (Tor_Cmd). The torque command information (Tor_Cmd) may include torque command information in different timings, such as current torque command information (Tor_Cmd_Now) or prior torque command information (Tor_Cmd_Last). In other words, prior torque command information (Tor_Cmd_Last) can be referred as a first driving force of the joint motor 210 (or the driver), and current torque command information (Tor_Cmd_Now) can be referred as a second driving force of the joint motor 210. Furthermore, the first driving force and the second driving force respectively include an anti-friction force and a motion force in order to resist the friction force of the robotic arm 200. Therefore, in a small movement or static state of the robotic arm 200, the anti-friction force is greater than the motion force, wherein the motion force is the force that drives the robotic arm 200 to move or remain static state.

The control system 100 includes a gain adjustment module 110 coupled to the controller 120, the speed controller 130 and the robotic arm 200. The gain adjustment module 110 receives current torque command information (Tor_Cmd_Now) and prior torque command information (Tor_Cmd_Last) of the speed controller 130, and the position absolute difference value (Pos_Err). Then, the gain adjustment module 110 calculates torque command absolute difference value (Tor_Cmd_Diff) (not shown) between the current torque command information (Tor_Cmd_Now) and the prior torque command information (Tor_Cmd_Last), and compares the torque command absolute difference value (Tor_Cmd_Diff) with a counting threshold (Cri) (not shown). The control system 100 includes the counting threshold (Cri) including function for limiting activation of mapping mechanism. When the torque command absolute difference value (Tor_Cmd_Diff) varies too much, that is, the difference between the current torque command information (Tor_Cmd_Now) and the prior torque command information (Tor_Cmd_Last) is too large, the subsequent mapping mechanism will be avoided from being activated, so that the control system 100 will not be unstable due to excessive gain. In some implementations, the counting threshold (Cri) of the control system 100 can be fine-tuned to 0.5 times the rated torque of the joint motor 210.

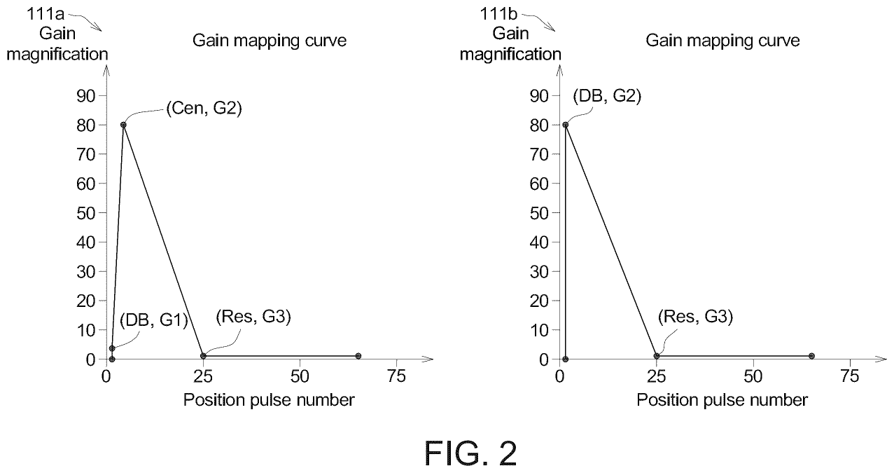

When the torque command absolute difference value (Tor_Cmd_Diff) is less than the counting threshold (Cri), it indicates that the difference between the current torque command information (Tor_Cmd_Now) and the prior torque command information (Tor_Cmd_Last) is not too much. Thus, the gain adjustment module 110 mapping the position absolute difference value (Pos_Err) between the command position information (Pos_Cmd) and the actual position information (Pos_Actual) according to a gain mapping curve 111, such that a current gain (G_Now) can be obtained according to the gain mapping curve 111 and the position absolute difference value (Pos_Err) (such as referring to the relevant description of FIG. 2). The current gain (G_Now) may correspond to position control loop, speed control loop and current control loop, and respectively provide or update to the controller 120, the speed controller 130 and the current controller 140, to adjust outputs of these components, thereby controlling the rotation state of the joint motor 210. In other words, the control system 100 may firstly use one of the control loops to try to control the motion of the robotic arm 200, or may use all of the control loops at once to control the motion of the robotic arm 200.

Conversely, when the torque command absolute difference value (Tor_Cmd_Diff) is greater than the counting threshold (Cri), it indicates that the difference between the current torque command information (Tor_Cmd_Now) the prior torque command information (Tor_Cmd_Last) is too much, such that the gain adjustment module 110 activates a counter (not shown) to count. When the number of count reaches two seconds, the counter is reset, that bypass a state in which the output torque of the robotic arm 200 changing too much in a short time (at least 500 ms). Then, the position absolute difference value (Pos_Err) is obtained, and the subsequent steps such as the gain mapping curve 111 of the gain adjustment module 110 are continued to obtain current (new) gain value (G_Now).

The control system 100 includes the current controller 140 coupled to the joint motor 210 and the gain adjustment module 110. The current controller 140 provides control current (Ctrl_Crt) to robotic arm 200 according to the current gain (G_Now), provided by the gain adjustment module 110, and the torque absolute difference value (Tor_Diff), to control rotation states of the joint motor 210.

The control system 100 includes a speed calculator 150 coupled to the speed controller 130 and the position decoder 220 of the robotic arm 200. The speed calculator 150 generates actual speed information (Spd_Actual) according to actual position information (Pos_Actual) received from the position decoder 220, such as differentiating and filtering the position information to obtain the speed information.

The aforesaid torque absolute difference value (Tor_Diff) is an absolute different value between a speed control signal 130S generated by the speed controller 130 according to the speed absolute different value (Spd_Diff) and the current gain (G_Now), and a current torque information (Tor_Actual) output by the current sensor 230, of the robotic arm 200, sensing the joint motor 210. The torque absolute difference value (Tor_Diff) can be calculated by an adder according to the speed control signal 130S and the current torque information (Tor_Actual), as shown in FIG. 1. The speed absolute different value (Spd_Diff) is an absolute different value between speed control information (Spd_Ctrl), provided by the controller 120 according to the current gain (G_Now), and actual speed information (Spd_Actual) generated by the speed calculator 150 according to the actual position information (Pos_Actual). The speed absolute different value (Spd_Diff) can be calculated by an adder according to the speed control information (Spd_Ctrl) and the actual speed information (Spd_Actual), as shown in FIG. 1.

As discussed above, the current gain (G_Now) obtained by the gain mapping curve 111 can correspond to the position control loop, the speed control loop and the current control loop, and be provided or updated to the controller 120, the speed controller 130 and the current controller 140 respectively, so as to provide the gain values currently required by these components, that is, provide the position gain value (G_Now for position) of the controller 120, the speed gain value (G_Now for speed) of the speed controller 130 and the current gain value (G_Now for current) of the current controller 140. Providing a compensated (such as adjustments) gain value can enhance the control capability of the joint motor 210 to reduce the influence of friction, thereby significantly improving the performance and accuracy of the robotic arm 200 in static and small movement conditions. The gain mapping curve will be described referring to FIG. 2 as follows.

FIG. 2 is a diagram illustrating gain mapping curve 111a of an example control system and gain mapping curve 111b of another example control system, according to some implementations of the present disclosure. The designs of the gain mapping curve 111a and the gain mapping curve 111b are mainly for processing the effects of friction when controlling the joint motor 210. As discussed above, the gain mapping curve 111a and the gain mapping curve 111b are one of the gain mapping curves 111 stored in the gain adjustment module 110. The mapping method can be obtained by plotting corresponding multiple position pulse numbers (gain dead zone position (DB), gain center position (Cen) and gain recovery position (Res)) and multiple gain intervals (first gain interval G1, second gain interval G2 and third gain interval G3) with the x-axis (gain ratio) and the y-axis (position pulse number) to obtain the gain mapping curve 111a and the gain mapping curve 111b.

In some implementations, the gain mapping curve 111a and the gain mapping curve 111b are generated by firstly setting the resolution of the position decoder 220, and setting the calculation method of gain dead zone position (DB), gain center position (Cen) and gain recovery position (Res) according to engineering experience (such as the development or testing stage), and setting values of the first gain interval G1, the second gain interval G2, and the third gain interval G3 according to the operation state of the robotic arm (such as the state related to the friction force). Next, the gain adjustment module 110 calculates the positions of the gain dead zone position (DB), the gain center position (Cen) and the gain recovery position (Res) on the X-axis of the gain mapping curve according to the resolution of the position encoder 220 and the calculation formula of the gain dead zone position (DB), the gain center position (Cen) and the gain recovery position (Res). Finally, the gain mapping curve is formed by using the set first gain interval G1, second gain interval G2 and third gain interval G3 and the calculated gain dead zone position (DB), gain center position (Cen) and gain recovery position (Res).

In some implementations, the gain magnification of the first gain interval G1 is 5, the gain magnification of the second gain interval G2 is 80, the gain magnification of the third gain interval G3 is 1, the position pulse number of the gain dead zone position (DB) is 3, the position pulse number of the gain center position (Cen) is 0.00005 times the resolution, and the gain recovery position (Res) is 0.00025 times the resolution. Wherein, different encoder systems can be designed with different multiples and resolutions. For example, when the resolution is 100000 Pulses, the gain center position (Cen) is 0.00005×100000, which the gain center position (Cen) is 5, and the gain recovery position (Res) is 0.00025*100000, which the gain recovery position Res is 25. Therefore, the coordinates of (DB, G1) are (3, 5), the coordinates of (Cen, G2) are (5, 80) and the coordinates of (Res, G3) are (25, 1), as shown in the gain mapping curve 111a.

In some implementations, only the gain dead zone position (DB), gain recovery position (Res), the second gain interval G2 and the third gain interval G3 may be designed in the gain mapping curve. For example, the gain magnification of the second gain interval G2 is 80, the gain magnification of the third gain interval G3 is 1, the corresponding position pulse number of the gain dead zone position (DB) is 3, and the gain recovery position (Res) is 0.00025*100000, which the gain recovery position (Res) is 25. Therefore, the coordinates of (DB, G2) are (3, 80) and the coordinates of (Res, G3) are (25, 1), as shown in the gain mapping curve 111b.

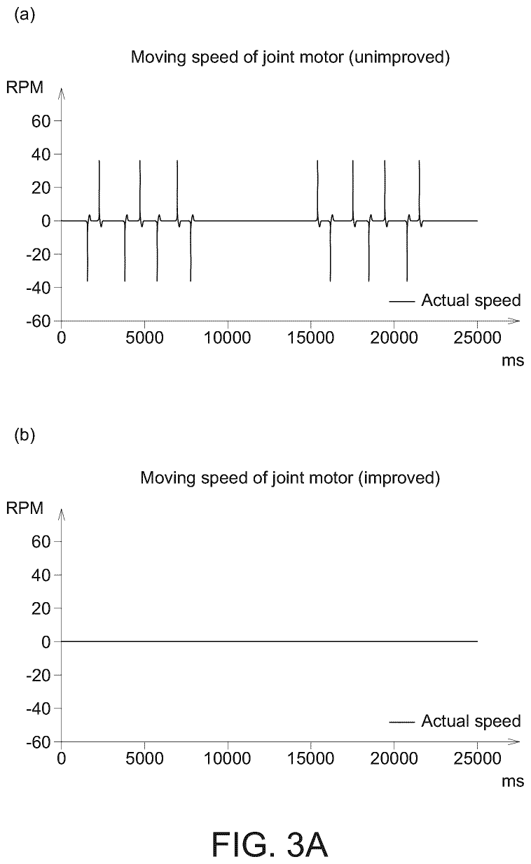

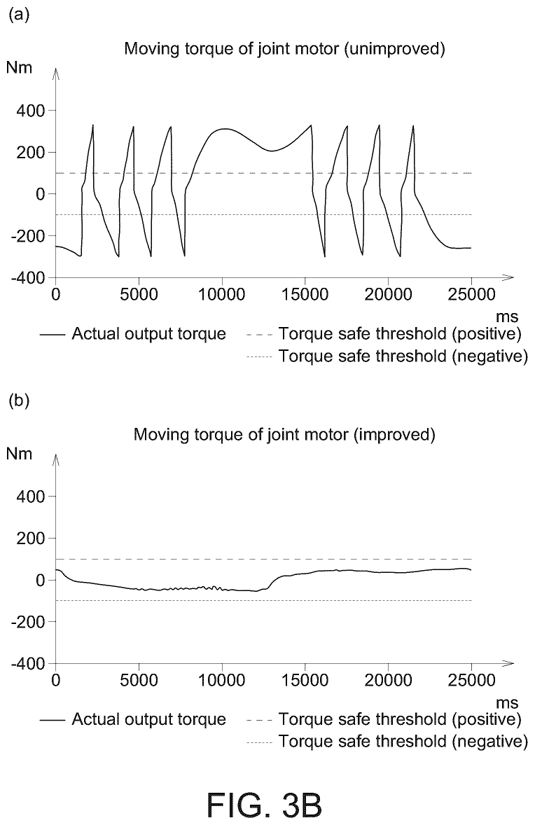

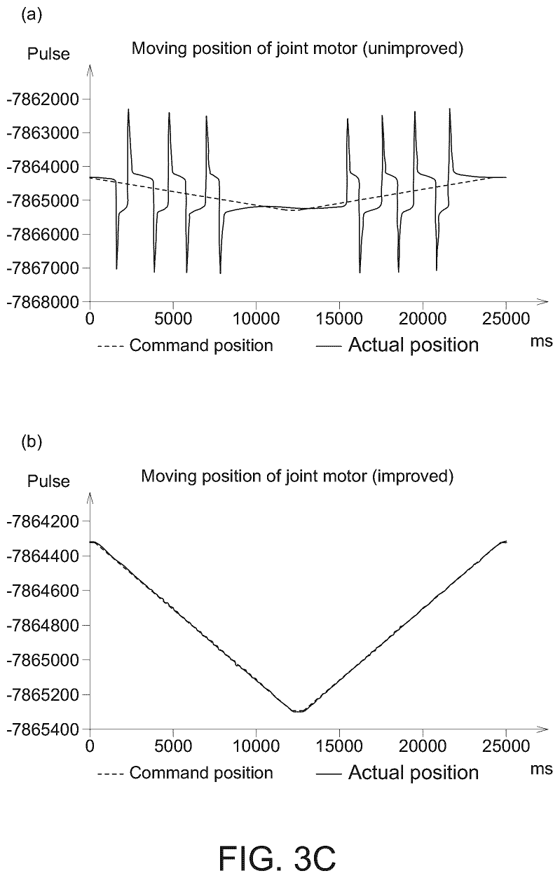

The control and improvement of the joint motor and the robotic arm by using the gain mapping curve 111a and the control system according to the implementations provided by the present disclosure will be described referring to FIGS. 3A to 3C as follows.

FIG. 3A is a diagram illustrating a moving speed comparison between conventional joint motor and the joint motor according to some implementations of the present disclosure. As shown by graph (a) and graph (b) in FIG. 3A, by using the gain mapping curve 111a and the control system 100 according to the implementations provided by the present disclosure, the moving speed of the joint motor 210 can be improved to make the moving speed average and stable. The graph (a) in FIG. 3A shows that under the control of the unimproved friction force (by conventional means), the joint motor 210 suddenly accelerates significantly (regardless of the positive or negative direction), thus causing the robotic arm 200 to move suddenly. The graph (b) in FIG. 3A shows that under the improved control, the joint motor 210 has less sudden and significant acceleration, and it is negligible even if a slight acceleration occurs.

FIG. 3B is a diagram illustrating a moving torque comparison between conventional robotic arm and the robotic arm according to some implementations of the present disclosure. As shown by graph (a) and graph (b) in FIG. 3B, by using the gain mapping curve 111a and the control system 100 according to the implementations provided by the present disclosure, the moving torque of the robotic arm can be improved so that the moving torque is smooth and does not exceed the positive or negative safety torque threshold. The graph (a) in FIG. 3B shows that before the influence of friction is decreased (conventional means), an excessive torque (whether moving or stopping) is often required to control the robotic arm to move. The graph (b) in FIG. 3B shows that after the influence of friction is decreased, the moving torque of the robot arm is slightly impacted by the friction and can often be within the safety torque threshold range.

FIG. 3C is a diagram illustrating a moving position comparison between conventional joint motor and the joint motor according to some implementations of the present disclosure. As shown by graph (a) and graph (b) in FIG. 3C, by using the gain mapping curve 111a and the control system 100 according to the implementations provided by the present disclosure, the accuracy for the moving position of the joint motor 210 can be improved to make the actual position consistent with the position command and reduce the swing (or shift) of the actual position. The graph (a) in FIG. 3C shows that before decreasing the influence of friction (conventional means), the control of the position command cannot reach the corresponding position, that often exceeds or falls short of the position corresponding to the original command. The graph (b) in FIG. 3C shows that after decreasing the influence of friction, the moving position (or rotation state, rotation position) of the joint motor 210 meets the setting of the position command.

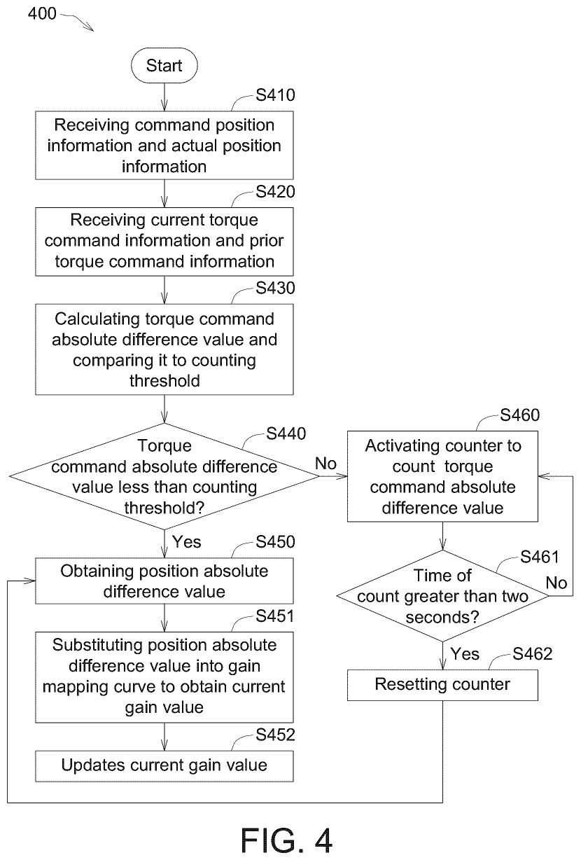

FIG. 4 is a flowchart illustrating control operations of robotic arm and joint motor according to some implementations of the present disclosure. In step S410, the controller 120 receives command position information (Pos_Cmd) and actual position information (Pos_Actual) from the position decoder 220. Wherein, the command position information (Pos_Cmd) is related to a first position of the robotic arm 200 to be controlled to move, and the actual position information (Pos_Actual) is related to the actual position (a second position) of the robotic arm 200 after the movement. The first position and the second position are related to a friction force of the robotic arm, which means that the greater the friction force, the closer the two positions are, or the greater the friction force, the more difficult it is to control small movements and static states.

In step S420, the gain adjustment module 110 receives the current torque command information (Tor_Cmd_Now) and the prior torque command information (Tor_Cmd_Last) from the speed controller 130.

In step S430, the gain adjustment module 110 calculates a torque command absolute difference value (Tor_Cmd_Diff) between the current torque command information (Tor_Cmd_Now) and the prior torque command information (Tor_Cmd_Last), and compares the torque command absolute difference value (Tor_Cmd_Diff) with a counting threshold (Cri).

In step S440, when the torque command absolute difference value (Tor_Cmd_Diff) is smaller than the counting threshold (Cri), moves to step S450 for obtaining a position absolute difference value (Pos_Err) between the command position information (Pos_Cmd) and the actual position information (Pos_Actual). In step S451, the gain adjustment module 110 substitutes the position absolute difference value (Pos_Err) into the gain mapping curve 111a or the gain mapping curve 111b, to obtain the current gain (G_Now) (includes which for position, speed and/or current). In step S452, the gain adjustment module 110 updates the current gain (G_Now) to the controller 120. In other words, by using the control loop, the first position and the second position, the second driving force can be adjusted to obtain a new driving force (or a third driving force) to control the robotic arm to move or remain static state.

In step S440, when the torque command absolute difference value (Tor_Cmd_Diff) is greater than the counting threshold (Cri), moves to step S460 which the gain adjustment module 110 activates a counter to count. In step S461, determines that the count is greater than two seconds or not. When the time of the count is greater than two seconds, according to engineering experience, the control system 100 can be prevented from being unstable due to excessive gain when the mapping mechanism is subsequently started. Moves to step S462 which resets the counter and movies to step S450, and then proceed to subsequent steps 451 and 452. When the time of the count is less than or equal to two seconds, return to step S460 and continue to start the counter to keep counting time.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A control method of a robotic arm, comprising:
outputting, by a driver, a first driving force to control the robotic arm located in a first position;
outputting, by the driver, a second driving force to control the robotic arm located in a second position, wherein the first position is different to the second position, and the first driving force and the second driving force respectively include an anti-friction force and a kinetic force smaller than the anti-friction force; and
adjusting, by using a control loop, the first position and the second position, the second driving force to control the robotic arm,
wherein the first position and the second position are related to a friction force of the robotic arm.

2. The control method of claim 1, further comprising:
receiving, by a controller, a command position information and an actual position information from a position encoder coupled to a joint motor as the driver;
receiving, by a gain adjustment module, a current torque command information and a prior torque command information from a speed controller;
calculating, by the gain adjustment module, a torque command absolute difference value between the current torque command information and the prior torque command information, and comparing the torque command absolute difference value with a counting threshold;
obtaining a position absolute difference value between the command position information and the actual position information, when the torque command absolute difference value is smaller than the counting threshold;
mapping, by the gain adjustment module, the position absolute difference value to a gain mapping curve to obtain a current gain value; and
updating, by the gain adjustment module, the current gain value to the control loop.

3. The control method of claim 2, further comprising:
activating, by the gain adjustment module, a counter to count, when the torque command absolute difference value is greater than or equal to the counting threshold;
resetting the counter and obtaining the position absolute difference value, when a counting time of the counter is greater than two seconds; and
keeping the counter counting, when the counting time of the counter is less than or equal to two seconds,
wherein the counting threshold is 0.5 times a rated torque of the joint motor.

4. The control method of claim 2, further comprising:
controlling, by a current controller, a rotation state of the joint motor according to the current gain value and a torque absolute difference value,
wherein the torque absolute difference value is an absolute difference value between an updated torque command information generated by the speed controller according to a speed absolute difference value and the current gain value, and a current torque information of the joint motor sensed by a current sensor,
wherein, the speed absolute difference value is an absolute difference value between a speed control information provided by the controller according to the current gain value, and an actual speed information generated by a speed calculator based on the actual position information.

5. The control method of claim 4, wherein the gain mapping curve is generated by the following steps:
setting a resolution of the position encoder;
setting a first gain interval, a second gain interval and a third gain interval;
calculating, by the gain adjustment module, a gain dead zone position, a gain center position and a gain recovery position based on the resolution of the position encoder; and
forming the gain mapping curve by using the first gain interval, the second gain interval, the third gain interval, the gain dead zone position, the gain center position and the gain recovery position.

6. The control method of claim 5, wherein a gain magnification of the first gain interval is 5, a gain magnification of the second gain interval is 80, and a gain magnification of the third gain interval is 1,
wherein a number of position pulses at the gain dead zone position is 3, a number of position pulses at the gain center position is 0.00005 times the resolution, and the gain recovery position is 0.00025 times the resolution.

7. A control system of a robotic arm, comprising:
a driver, configured to output a first driving force to control the robotic arm located in a first position and output a second driving force to control the robotic arm located in a second position, wherein the first position is different to the second position, and the first driving force and the second driving force respectively include an anti-friction force and a kinetic force smaller than the anti-friction force; and
a control loop, configured to adjust the second driving force to control the robotic arm according to the first position and the second position,
wherein the first position and the second position are related to a friction force of the robotic arm.

8. The control system of claim 7, further comprising:
a controller, coupled to a position encoder, coupled to a joint motor as the driver, of the robotic arm, and the controller configured to receive a position absolute difference value between a command position information and an actual position information provided by the position encoder;
a speed controller, coupled to the controller and configured to generate a current torque command information and a prior torque command information; and
a gain adjustment module, coupled to the controller, the speed controller and the position encoder and configured to receive the current torque command information, the prior torque command information and the position absolute difference value, to calculate a torque command absolute difference value between the current torque command information and the prior torque command information, and compare the torque command absolute difference value to a counting threshold,
wherein, when the torque command absolute difference value is smaller than the counting threshold, the gain adjustment module maps the position absolute difference value to a gain mapping curve to obtain a current gain value and updates the current gain value to the control loop.

9. The control system of claim 8, wherein, when the torque command absolute difference value is greater than or equal to the counting threshold, the gain adjustment module activates a counter to count,
wherein, when a counting time of the counter is greater than two seconds, the counter is reset and the position absolute difference value is obtained,
wherein, when the counting time of the counter is less than or equal to two seconds, the counter keeps counting,
wherein the counting threshold is 0.5 times a rated torque of the joint motor.

10. The control system of claim 8, further comprising:
a current controller, coupled to the joint motor, the gain adjustment module and the speed controller and configured to control a position of the joint motor according to the current gain value and a torque absolute difference value; and
a speed calculator, coupled to the position encoder and the speed controller and configured to generate an actual speed information according to the actual position information received from the position encoder,
wherein the torque absolute difference value is an absolute difference value between an updated torque command information generated by the speed controller according to a speed absolute difference value and the current gain value, and a current torque information of the joint motor sensed by a current sensor of the robotic arm,
wherein, the speed absolute difference value is an absolute difference value between a speed control information provided by the controller according to the current gain value, and the actual speed information generated by the speed calculator.

11. The control system of claim 10, wherein the gain mapping curve comprises:
a first gain interval, a second gain interval and a third gain interval generated by the gain adjustment module;
a gain dead zone position, a gain center position and a gain recovery position generated by the gain adjustment module according to a resolution of the position encoder; and
a mapping relation between the first gain interval, the second gain interval and the third gain interval, and the gain dead zone position, the gain center position and the gain recovery position.

12. The control system of claim 11, wherein a gain magnification of the first gain interval is 5, a gain magnification of the second gain interval is 80, and a gain magnification of the third gain interval is 1,
wherein a number of position pulses at the gain dead zone position is 3, a number of position pulses at the gain center position is 0.00005 times the resolution, and the gain recovery position is 0.00025 times the resolution.
